(19) United States
(12) Patent Application Publication
(10) Pub. No.: US 2013/0014930 A1
(43) Pub. Date: Jan. 17, 2013

(54) ENERGY CONSERVING CHILLING UNITS AND METHODS

(71) Applicant: Thomas B. O'Brien, Blaine, WA (US)

(72) Inventor: Thomas B. O'Brien, Blaine, WA (US)

(21) Appl. No.: 13/344,371

(22) Filed: Jan. 5, 2012

Related U.S. Application Data
(60) Provisional application No. 61/430,649, filed on Jan. 7, 2011.
(60) Provisional application No. 61/536,281, filed on Sep. 19, 2011.

(51) Int. Cl. F28F 9/00; G05D 23/00; F28F 13/12

(52) U.S. Cl. 165/287; 165/157; 165/121

(57) ABSTRACT

The present invention relates to the methods and devices for using the ambient atmosphere to increase the energy efficiency of refrigerators and freezers. The invention generally provides energy-conserving chilling systems, devices, and methods, which involve a compartment in a case coupled to a fluid conduit and configured to be positioned within a building to allow passage of a fluid via the conduit from an exterior of the building to the case, thereby decreasing an interior temperature of air within the compartment.

### CROSS-REFERENCE TO RELATED APPLICATION

This patent application claims the benefit of U.S. Provisional Patent Application Ser. No. 61/430,649 to Thomas O'Brien, titled METHOD AND SYSTEM FOR THE REDUCTION OF ELECTRICAL CONSUMPTION PERTAINING TO REFRIGERATION AND/OR FREEZING OF FOOD OR OTHER PRODUCTS REQUIRING COOLING, filed on Jan. 7, 2011, and U.S. Provisional Patent Application Ser. No. 61/536,281 to Thomas O'Brien, titled METHOD AND SYSTEM FOR THE REDUCTION OF ELECTRICAL CONSUMPTION PERTAINING TO REFRIGERATION AND/OR FREEZING OF FOOD OR OTHER PRODUCTS REQUIRING COOLING, filed on Sep. 19, 2011, the contents of both of which are incorporated herein by reference in their entirety.

### FIELD OF INVENTION

The present invention relates to the methods and devices for using the ambient atmosphere to increase the energy efficiency of refrigerators and freezers.

### BACKGROUND OF THE INVENTION

A refrigerator or freezer is a common household appliance that consists of a thermally insulated compartment and a heat pump (usually mechanical) that transfers heat from the inside of the refrigerator/freezer to its external environment so that the inside of the appliance is cooled to a temperature below the ambient temperature of the room. Cooling is a popular food storage technique in developed countries and works by decreasing or even arresting the reproduction rate of bacteria. The device is thus used to reduce the rate of spoilage of foodstuffs and other products that require cooling, such as, for example, medicines, chemicals, and medical specimens among others.

A refrigerator maintains a temperature a few degrees above the freezing point of water. Optimum temperature range for perishable food storage is 3 to 5° C. (37 to 41° F.). A similar device which maintains a temperature below the freezing point of water is called a freezer.

The refrigerator is a relatively modern invention among kitchen appliances. It replaced the icebox, which had been a common household appliance for almost a century and a half prior. For this reason, a refrigerator is sometimes referred to as an icebox.

Freezer units are used in households and in industry and commerce. Most household freezers maintain temperatures from −10 to 0° F. (−23 to −18° C.), although some freezer-only units can achieve −30° F. (−34° C.), and lower. Refrigerators generally do not achieve lower than −10° F. (−23° C.), since the same coolant loop serves both compartments: Lowering the freezer compartment temperature excessively causes difficulties in maintaining above-freezing temperature in the refrigerator compartment. Domestic freezers can be included as a separate compartment in a refrigerator, or can be a separate appliance. Domestic freezers are generally upright units resembling refrigerators, or chests (resembling upright units laid on their backs). Many upright modern freezers come with an ice dispenser built into their door.

Commercial refrigerator and freezer units, which go by many other names, were in use for almost 40 years prior to the common home models. They used gas systems such as anhydrous ammonia (R-717) or sulfur dioxide (R-764), which occasionally leaked, making them unsafe for home use and industrial purposes. Practical household refrigerators were introduced in 1915 and gained wider acceptance in the United States in the 1930s as prices fell and non-toxic, non-flammable synthetic refrigerants such as Freon-12® (R-12) were introduced. However R-12 damaged the ozone layer, causing governments to issue a ban on its use in new refrigerators and air-conditioning systems in 1994. The less harmful replacement for R-12, R-134a (tetrafluoroethane), has only been in common use since 1990, but R-12 is still found in many old systems today.

A refrigerator/freezer is usually the single largest electrical load within a house; a refrigerator/freezer uses more energy than the stove and oven, microwave, dishwasher, dryer, and often the total installment of incandescent lights. This is because a refrigerator/freezer runs all day and all night. A typical refrigerator-freezer uses approximately 16% of all household electric consumption.

Attempts have been made to make refrigerator/freezers more energy efficient, however even the most highly efficient units do not take advantage of the available ambient air cooling in colder climates. Instead, refrigerator/freezers are typically “an island” in the interior room of a house or commercial environment which is operated by removing heat from the interior of the unit and expelling it out into the interior ambient air of the house or commercial environment.

Since refrigeration is one of the top electrical consuming items in a home or restaurant, aggregate electrical energy demand associated with refrigeration puts significant pressure on the entire national energy grid and requires expensive capital costs for enhancing grid capacity if “brownouts” or “rolling blackouts” are to be avoided. Satisfying existing power demands will likely require infrastructure improvements that could cost on the order of hundreds of billions of dollars.

### SUMMARY OF THE INVENTION

Accordingly, a method and system is disclosed for the reduction of electrical consumption pertaining to refrigeration or freezing of food or other products requiring cooling. The method and system can significantly lower the electric consumption of chilling units (e.g., refrigerators, walk-ins, or freezers). An embodiment of the present invention uses outdoor ambient temperature to supplement or replace the operation of the cooling mechanics by importing thermal energy (i.e., exporting heat energy) from outdoor cool air. This invention is particularly useful in climates where the ambient air temperature often is lower than 35° F. The invention optionally provides refrigerators and freezers as separate chilling units or as combined chilling units, for example, with a refrigerator and freezer above one another or side-by-side. The chilling units of the invention are useful for refrigerating or freezing food and beverages, and other products that require cooling, such as, for example, medicines, medical and/or research reagents, and medical specimens among others.

In one embodiment, the invention provides household and commercial refrigerators and freezers that are configured for using the thermal energy of the ambient atmosphere to increase their energy efficiency. The invention takes advantage of a differential in heat energy between the inside of a chilling unit and the exterior, preferably the outdoors. By transferring exterior air in, or through the use of heat exchanging mechanisms, heat energy is removed from the chilling unit thereby contributing to conditions to chill contents of the unit. Exemplary methods of cooling based on external air temperature differentials are described in part in External Air Assisted Building Heating and Cooling, U.S. Pub. 2008/0054085 to Case, the contents of which are hereby incorporated by reference in their entirety. Exemplary structures for conduits and triggering mechanisms as well as cooling methods are illustrated and discussed in Energy Efficient Domestic Refrigeration System, U.S. Pat. No. 5,743,109 to Schulak, the contents of which are hereby incorporated by reference in their entirety.

The concept is to use ambient air temperature to lower an interior temperature in a chilling unit. Devices and methods of the invention can supplement or replace the operation of cooling compressors that are in conventional refrigerators and freezers. In some embodiments, devices and methods of the invention provide a chilling mechanism for a chilling unit. Use of the invention can substantially reduce energy consumption, including, for example, decreasing the amount of electrical power consumed by a utility customer.

In certain embodiments, methods and devices of the invention operate to draw exterior air into a compartment of a chilling unit. A vent is provided to couple an interior compartment to an exterior space. With the vent in an open configuration, air from outside is drawn into the chiller (e.g., refrigerator or freezer) using a pump, fan, or phenomenon to circulate air. Circulating the air includes drawing in exterior air that has an ambient temperature that is lower than an initial temperature of air that is in the compartment of the chilling unit. The exterior air is preferably drawn in through one or more filters such, for example, activated carbon or woven filters. These filters assure that the outside air being circulated is free of any contaminates and/or particulates.

In an alternative embodiment, the invention provides a heat exchange system for a chilling unit involving a cooling fluid and one or more heat exchangers. The system and method can include several components, and preferably includes an external heat exchanger, such as, for example, an aluminum or other conductive radiator or heater core. The invention exploits existing economies of scale in the production of devices to provide affordable components. An optimal heat exchanger in relation to efficiency and cost based on basic maxima-minima calculation can be employed.

An external heat exchanger may be placed on or near an exterior wall of a home or building, preferably where it is not exposed to direct sunlight (e.g., north facing in the northern hemisphere) and may be mounted high enough to avoid interference from human or animal sources. A high efficiency fan may be used to draw the cold air through the exchanger so that the cold air removes heat energy from the cooling fluid.

A cooling solution (such as a phosphate-based non-toxic solution or a solution such as ethylene glycol) is fed through the external unit. The external heat exchanger can include a reservoir having a containment wall with an internal surface and an external surface, the external surface having a surface area, which may generally be substantially similar to an area of the internal surface. The reservoir is configured to house the cooling fluid in contact with the internal surface while external air is in contact with an external surface. The external heat exchanger is configured so that, if a temperature of a cooling fluid in the reservoir is higher than a temperature of the external air, heat energy is transferred from the cooling fluid to the external air, thereby cooling the fluid. In some embodiments, the reservoir is a radiator, for example, including hosing or piping. Again, a cost benefit (e.g., maxima-minima) relationship will determine the characteristics of the hosing or piping. Methods and devices of the invention transfer the cooling fluid from the external heat exchanger to the interior of the chilling unit. Fluid can be transferred by a pump, such as a low-power pump, gravity, or pressure differential. Flow rates and rheology may come into play, as a very low flow rate may indeed be optimal. As refrigerator/freezer temperatures begin to change beyond optimal levels, a small sub-system can be employed to begin use in cooling the refrigerator and/or freezer compartments, or perhaps a separate unit. For example, as outside ambient air temperatures drop below the freezing point with refrigerator/freezer temperatures approaching the freezing point the freezer function will be initiated utilizing the same basic sub-system using basically the same components.

This system thus supplements or replaces the use of a compressor which is believed to be the most power consumptive element of a conventional refrigerator/freezer. Filter techniques, as outlined above, can be used to avoid any contamination from outside air, which can be dramatic in terms of actual toxicity and related effects on food taste and texture. This system also has the effect of making the entire mechanism external to the refrigerator.

As compared to alternatives that must be placed close to or abutting exterior walls, methods and devices of the invention provide the benefit that a chilling unit (i.e., refrigerator and/or freezer) may be located anywhere in a room as per architecture and taste in design. This feature makes it completely distinctive to alternatives which must be close to or actually abutting walls that are exposed to the interior. The location on refrigerator units in a commercial setting can have a significant effect on productivity. The system is preferably as closed as is possible with very minimal leakage either into or outside the system. Optimally there will be almost zero coolant loss or accumulation of condensate-based water.

In some embodiments, the cooling fluid is about 50% cooling product and about 50% water, and can be maximized technically. Freezing of the coolant should not be a problem above minus 40° C. Obviously, latitude and altitude as they relate to mean temperatures will be the determining factor. As a “ballpark” figure, a 40% reduction in energy use can be anticipated in borderline or seasonal mean temperature environments predominantly at or below 0° C. and the use of timers may come into play in areas, such as the desert environment, with extreme diurnal temperature differences.

In another embodiment of the present invention, the pumping system of the refrigerator in the previously described embodiments could be replaced or supplemented with a manual, hand operated pump. This hand operated pump could include for example, a cranking mechanism used to wind a spring engine whereupon discharge of the spring energy over time could power the pump. The hand operated pumping mechanism would include on/off relays or mechanisms so as to conserve the spring energy for use when the temperature in the refrigerator called for pump activity. The spring energy can be used to supplement and/or replace the energy provided to the pumping system conventionally provided by the electric motor or used in other embodiments in the present invention.

The invention generally provides systems, methods, and devices for chilling the contents of a compartment within a case (e.g., the food compartment of a refrigerator) by drawing a fluid from outdoors into the case. In various embodiments, the fluid is air or a cooling fluid.

The invention includes systems, methods, and devices suited to air-based embodiments.

In certain aspects, the invention provides an energy-conserving chilling system including a case that provides a compartment, the case being coupled to a fluid conduit and configured to be positioned within a building to allow passage of air from an exterior of the building to the case, thereby decreasing an interior temperature of air within the compartment. The fluid conduit includes an intake air vent configured to draw external air into the compartment to mix with air in the compartment, thereby decreasing an overall temperature of air within the compartment.

The system can include various devices, features, and accessories to optimize functionality, including, for example, a filter to remove components from the air; an electric fan; and an air exhaust vent.

In some embodiments, the case is provided by a household refrigeration appliance.

In certain aspects, the invention provides an energy-conserving method of chilling a product that includes drawing air via a conduit from outside of a building into a compartment within a case, the case being located within the building, thereby reducing an internal air temperature within the compartment. The method may include activating a fan to draw in the air responsive to a determination of an external air temperature. The case is optionally provided by a household refrigeration appliance such that the compartment is a refrigeration compartment. The method can further include removing air from the compartment by means of an exhaust vent. The air can be drawn in responsive to a determination that the external air temperature is lower than an internal air temperature in the refrigerator compartment. The method can further include, separately drawing, via a second conduit, air into a freezer compartment, for example, responsive to a determination that the external air temperature is below a freezing temperature or other criteria.

In certain aspects, the invention provides a device for chilling a product including a fluid conduit to be installed to a chilling appliance to draw air from outside of a building into a compartment within the appliance, thereby reducing an internal air temperature within the compartment. The conduit optionally includes an air intake vent, a fan, or an air exhaust vent. The conduit can further include a mechanism to turn the fan on when it is colder outside.

The invention includes systems, methods, and devices suited to the cooling fluid-based embodiments. In certain aspects, a cooling fluid is used in an energy-conserving chilling system. The system can include a case providing a compartment, the case being coupled to a fluid conduit and configured to be positioned within a building to allow passage of cooling fluid from an exterior of the building to the case, thereby decreasing an interior temperature of air within the compartment. The cooling fluid can exist in solid, liquid, or gaseous states, but generally includes a composition that is at least partially unfrozen (i.e., fluid—liquid or gas) at temperatures in which the invention operates. The fluid conduit is optionally a component of a closed system containing the cooling fluid (i.e., so that it does not contact or diffuse into surrounding air). The system generally includes an external heat exchanger configured to be positioned outside of the building, wherein the external heat exchanger includes a reservoir with an internal surface to contact the cooling fluid and an external surface to contact external air. In some embodiments, the system also includes an internal heat exchanger, for example, disposed within the case (which can be part of a household refrigeration appliance such as a refrigerator, freezer, or combination thereof). The internal heat exchanger can be coupled to the external heat exchanger by the fluid conduit to provide a closed fluid system that prevents commingling of the cooling fluid and air. A fluid pump can be provided to assist the flow of fluid between the case and the external heat exchanger.

In some aspects, the invention provides methods for chilling a product by drawing a fluid through a conduit from the outside of a building into a compartment within a case located within the building to reducing the temperature within the compartment. The method preferably involves flowing the cooling fluid through an external heat exchanger to transfer heat energy from the cooling fluid to outside air. By passing the cooling fluid through an internal heat exchanger disposed within the case, heat energy can be transferred from air within the case to the cooling fluid, thereby decreasing the internal air temperature. Fluid can be moved within the system, at least in part, through the use of a pump.

In certain aspects, the invention provides a device including a fluid conduit configured to be coupled to a chilling appliance (such as a household refrigeration appliance) to draw a cooling fluid from outside of a building into a compartment within the chilling appliance, thereby reducing an internal air temperature within the compartment. The device can include an external heat exchanger configured to be positioned outside of the building. The device preferably also includes an internal heat exchanger configured to be installed in the chilling appliance as well as optionally a pump.

### BRIEF DESCRIPTION OF THE DRAWINGS

The present invention, both as to its organization and manner of operation, will be more fully understood from the following detailed description of illustrative embodiments taken in conjunction with the accompanying drawings in which:

FIG. 1 is a schematic diagram of a method and system for utilizing the ambient outdoor temperatures to reduce the consumption of energy to keep the temperature of the refrigerator/freezer using air from outdoors to be injected into the interior of the refrigerator to supplement or replace the use of the compression system in the refrigerator;

FIG. 2 is a schematic diagram of the components of the method and system for utilizing heat exchangers for utilizing the ambient outdoor temperatures to reduce the consumption of energy to keep the temperature of the refrigerator/freezer using thermal energy from outdoors to be derived by a primary heat exchanger directed into a secondary heat exchanger into the interior of the refrigerator/freezer to supplement or replace the use of the compression system in the refrigerator/freezer.

### DETAILED DESCRIPTION

The exemplary embodiments of the method and system for using the ambient atmosphere or a fluid-based system to increase the energy efficiency of household and commercial refrigerators and freezers are discussed in terms of two embodiments including the use of filtered ambient air injection and the use of heat exchangers to facilitate supplementing or replacing the conventional compression system for cooling. In addition, mechanical assistance to the energy requirements of the refrigerator may be delivered via a hand crank.

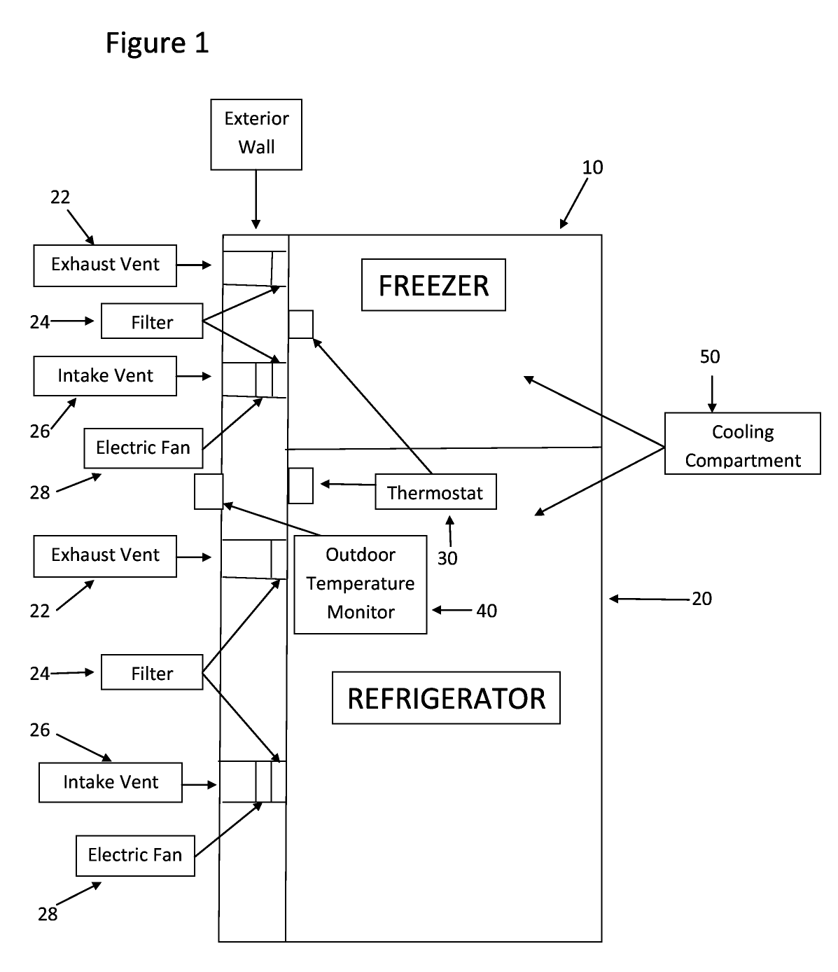

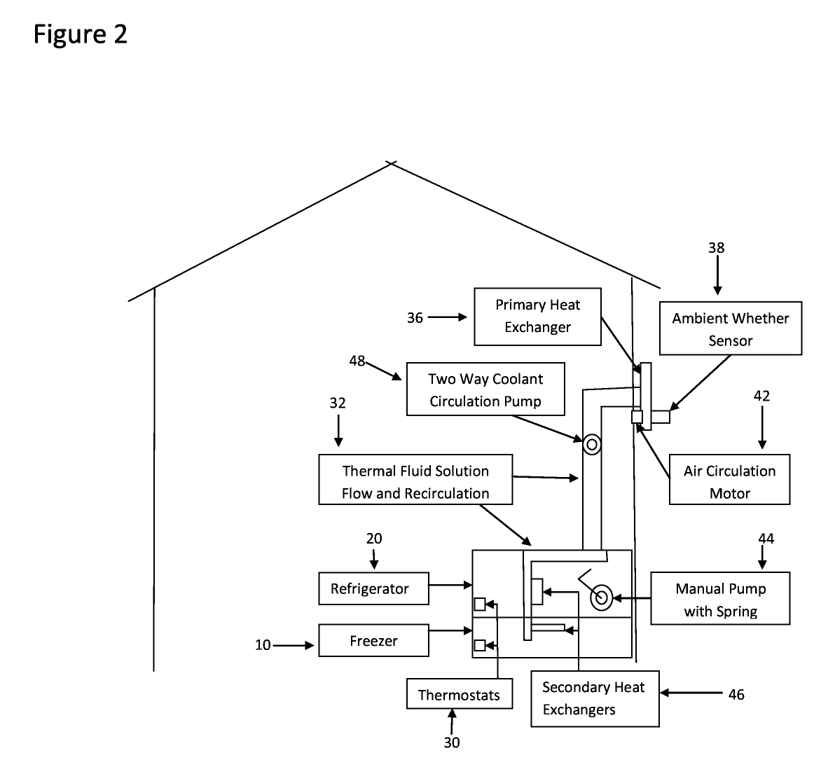

The following discussion includes a description of the methods, devices, and systems for conserving energy in accordance with the principles of the present disclosure. Alternate embodiments are also disclosed. Reference will now be made in detail to the exemplary embodiments of the present disclosure, which are illustrated in the accompanying figures. Turning now to FIGS. 1 and 2, there is illustrated a method and system for chilling the contents of the system, such as, for example, a freezer system 10 for providing a subfreezing environment. The system for cooling contents of a refrigerator is described for refrigerator system 20.

Detailed embodiments of the present disclosure are disclosed herein, however, it is to be understood that the described embodiments are merely exemplary of the disclosure, which may be embodied in various forms. Therefore, specific functional details disclosed herein are not to be interpreted as limiting, but merely as a basis for the claims and as a representative basis for teaching one skilled in the art to variously employ the present disclosure in virtually any appropriately detailed embodiment.

Refrigerator 20 is a refrigeration unit which maintains a temperature capable of preserving food or other materials, preferably not freezing the material. Freezer 10 is a freezer which is capable of maintain temperatures in which the cooling compartment 50 is maintained generally below the freezing point, (below 32° F. or where the internal thermostat 30 is set) of the contents of that cooling compartment 50. Thermostats 30 signal to the electric compressor when it should circulate coolant through the mechanical cooling system in order to remove heat from the inside of the freezer 10 and/or the refrigerator 20. When the outdoor temperature monitor 40 indicates that the outdoor temperature meets a specified criterion (i.e., more than 5° F. cooler than the preset internal temperature of the cooling compartment 50 in the refrigerator 20 and/or freezer 10), the electric fan 28 in the intake vent 26 can begin drawing outside ambient into the cooling compartment 50, optionally through optional filter 24. As cold filtered air is injected into the cooling chamber the warmer air is optionally expelled through the exhaust vent 22.

In FIG. 2 the device and method include several important components. The internal refrigerator 20 and freezer 10 are moderated by one or more of thermostat 30. The external component is a external primary heat exchanger 36, such as a metal, ceramic, plastic, rubber, or similar radiator, heater core, or reservoir. Research shows that the availability and cost of such devices and materials due to inherent mass production may result in low prices. An optimal primary heat exchanger 36 in relation to efficiency and cost based on basic maxima-minima calculation can be employed.

The external primary heat exchanger 36 is preferably mounted at an optimal location (for example, not exposed to direct sunlight, protected from children and vehicles, accessible for maintenance, mounted or insulated as to limit any heating from the interior of the structure, etc.). A low power anemometer may be used in concert to optimize cooling at the exterior of the system. A plan view of a system and method set-up in accordance with this embodiment of the invention is depicted in FIG. 2

The optional ambient weather sensor 38 can be used to determine when the primary heat exchanger 36 should be put into operation. It may contain a temperature gage as well as an anemometer. The anemometer (and perhaps hygrometer) will determine wind velocity, and through the use of relay(s) and actuators, modulate the employment of the air circulation motor 42 which can be optimized based on digital input. Generally, local historical temperature and wind data can be integrated into function. In some embodiments, weather sensor 38 includes a connection to an internet service.

A cooling fluid circulation system 32 is used to circulate the cooling fluid. The cooling fluid (which can include, for example, phosphate-based solutions or ethylene glycol) is fed through the external primary heat exchanger 36 thereby allowing heat energy to be transferred from the cooling fluid to the external air. Again, a cost benefit (maxima-minima) relationship will determine the characteristics of the hosing or piping. The cooling fluid can transported to the interior of the refrigerator and transported into an internal heat exchanger 46, for example, using a two-way circulation pump 48. Flow rates and rheology come into play, as a very low flow rate may indeed be optimal. As refrigerator/freezer temperatures begin to change beyond optimal levels, a small sub-system can be employed to begin use in cooling the refrigerator and/or freezer compartments, or perhaps a separate unit. For example, as outside ambient air temperatures drop below the freezing point with refrigerator/freezer temperatures approaching the freezing point the freezer function will start up utilizing the same basic sub-system using basically the same components.

This system thus supplements or replaces the use of a compressor which is believed to be the most power consumptive element of a conventional refrigerator/freezer. Filter techniques, as outlined above, can be used to avoid any contamination from outside air, which can be dramatic in terms of actual toxicity and related effects on food taste and texture. This system also has the effect of making the entire mechanism external to the refrigerator.

In another aspect of the present disclosure, and as shown in FIG. 2, the pumping system of the refrigerator could be replaced or supplemented with a manual pump 44. This pump could include for example, a cranking mechanism used to wind a spring engine whereupon discharge of the spring energy over time could power the two-way circulation pump 48. The hand operated pumping mechanism would include on/off relays or mechanisms so as to conserve the spring energy for use when the temperature in the refrigerator called for pump activity.

In some embodiments, two-way circulation pump 48 pumps fluid in one direction, with the result that fluid is delivered from the external heat exchanger to the internal heat exchanger and from the internal heat exchanger to the external heat exchanger (e.g., “two-ways”), due to an interplay with pressure (e.g., associated with a closed system), gravity, or another force.

Finally, this type of system allows for the placement of the refrigerator in the kitchen as per architecture and taste in design. This feature makes it completely distinctive to alternatives which must be close to or actually abutting walls that are exposed to the interior. The system is preferably as closed as is possible with very minimal leakage either into or outside the system. Optimally there will be almost zero coolant loss or accumulation of condensate-based water. The coolant is typically 50% product and 50% water and can be maximized technically. Freezing of the coolant should not be a problem above minus 40° C. Obviously, latitude, altitude as they relate to mean temperatures will be the determining factor. As a “ballpark” figure, a 40% reduction in energy use can be anticipated in borderline or seasonal mean temperature environments predominantly at or below 0° C. and the use of timers may come into play in areas, such as the desert with extreme diurnal temperature differences.

It will be appreciated that a fluid is a substance that deforms in response to an applied stress and generally takes the shape of a container. Exemplary fluids according to the invention include, without limit, air; hydrogen; the inert gases; sulfur hexafluoride; water; ethylene glycol; diethylene glycol; propylene glycol; solutions of ethylene glycol, diethylene glycol, or propylene glycol in water; betaine; deionized water; heavy water; polyalkylene glycol; mineral oils; castor oil; silicone oils; fluorocarbon; freons; halomethanes; propane; haloalkanes; ammonia; anhydrous ammonia; carbon dioxide; petroleum oils; liquid nitrogen; nanofluids (e.g., a carrier liquid, such as water, and nanoparticles of e.g. CuO, alumina, titanium dioxide, carbon nanotubes, silica, or metals (e.g. copper, or silver nanorods, e.g. silver nanorods of 55±12 nm diameter and 12.8 μm average length at 0.5 vol. % or 0.5 vol. % of silver nanorods in ethylene glycol or alumina nanoparticles at 0.1%)); and similar. In general, as used herein, air means the Earth's atmosphere. Fluid generally means any fluid, including air or any of the others listed above.

The invention provides for cooling the contents of a compartment. A compartment can be, for example, the inside of a refrigerator or freezer, which includes a standard household refrigerator having both, as well as also standalone units and walk-ins (such as at a restaurant). The compartment can also be within a commercial or retail case, such as a beverage display case, vending machine, or freezer aisle cabinet.

In some embodiments, the fluid is air—the air that surrounds users and providers of the invention, or permeates a compartment, or surrounds a building. Where air is to be conducted through a fluid conduit, such a conduit may be duct-work including such materials as galvanized mild steel, polyurethane, fiberglass, flexible materials such as FLEX, plastic over a metal coil (e.g., “dryer hose”), fabric, or other materials known in the art, such as the HVAC art. A fan can be an 8″ duct fan for metal work mounted using a Broan 332KR rough-in kit, a Suncourt DB200 6″ 110V fan, or similar (see, e.g., Inductor 4″ in-line duct fan). Ductwork may be assembled with duct tape, cement, other adhesives, press-fits, spot welding, welding, rivets, or other fastening or assembly means known in the art. A flange may be provided to connect the duct-based air conduit to a wall of an appliance or through a wall of a building. Round and rectangular flange kits and base plates are available and known in the art. Exemplary fluid conduits for air as well as multi-compartment devices and methods are described in Refrigerator with Heat Exchanger Optimally Configured, U.S. Pat. No. 5,497,634 to Kojima, the contents of which are hereby incorporated by reference in their entirety.

An air conduit, or air duct, can include a filter. Exemplary filter devices known in the art include a 4″ 2600 carbon filter with duct flange (round), a hydroponic 6″ inline fan and carbon air filter unit, a duct filtration dryer box (e.g., MFL-315, 12.4″), or a commercial air duct and purifier unit such as a high-efficiency particulate arresting filter.

In some embodiments, the invention includes, or can be installed with, a household refrigeration appliance. In general, the appliance is in a building, such as a house, a shed, a garage, a commercial building like a hospital or restaurant, hotel, or apartment building. Building broadly includes structures and thus includes structures such as Quonset huts, tents, lean-tos or structures inside of buildings such as a utility shed inside of a warehouse.

The invention can include thermostat mechanisms or other switching mechanisms. In some embodiments, a fan or a pump is activated or deactivated responsive to a determination of temperature or change in temperature by a dedicated thermostat, thermometer, or other mechanism. In some embodiments, activation or deactivation is responsive to weather data, from a weather station or the internet, a pre-programmed schedule, a manually operated switch or remote control, such as including an app provided to be downloaded to a smartphone. In some embodiments, the invention includes a computing device including a memory and a processor or a computer-readable medium having computer program instructions stored thereon, executable by a processor, to assist in operating components of the invention. Components of the invention can be connected to other systems such as, for example, a household furnace or thermostat or commercial HVAC unit to respond to status or information provided thereby. Other exemplary switching mechanisms are described in Energy Saving For Household Appliances, U.S. Pub. 2011/0093131 to Biswas, the contents of which are hereby incorporated by reference in their entirety.

In certain aspects, the invention provides a device or kit, for example, to be sold at a home improvement store or installed by a consumer into their home for their refrigeration appliance (e.g., a retrofit kit or device).

As used herein and unless otherwise specified, “or” means “and/or”, is inclusive, or is satisfied by satisfaction of any one of the elements it conjoins.

In various embodiments, the invention includes accessories or components to enhance appeal. For example, the invention may include a meter, processor, or combination of mechanisms to calculate and report an amount of energy conserved (otherwise used but-for the methods and devices of the invention). The invention can include one or more exterior cases, shells, housings, finishes, or decorative panels to cover any component for protection or attractiveness. It is recognized that under some conditions methods and devices of the invention will outperform goals of the invention (e.g., freeze the contents of a refrigerator) and thus the invention can include thermostats or other mechanisms to stop the function of any fan or pump or otherwise selectively inhibit the affect of the invention.

In some embodiments, the invention includes a fluid as a cooling fluid. A cooling fluid can generally exist in solid, liquid, or gaseous states, but generally includes a composition that is at least partially unfrozen (i.e., fluid—liquid or gas) at temperatures in which the invention operates.

A heat exchanger according to the invention can include a radiator, an assemblage of pipes, capillaries, reservoirs, or other vessels to contain fluid on one side (an inside) and allow heat transfer across a boundary thereof. Exemplary heat exchangers include a water coil, water to air heat exchanger, a Bell & Gossett plate and frame heat exchanger, a Dayton 1VLE4 non-tubular heat exchanger, a Brazetek water to air finned coil heat exchanger, or any other suitable device built specially or known in the art.

At least in embodiments in which the fluid is a cooling fluid, fluid conduits can be provided by ducts, hoses, pipes or other means known in the art. Exemplary pipes include copper pipe, lead pipe, PVC pipe, rubber hose, and similar.

In another aspect, the invention provides household and commercial refrigerators and freezers that are configured for using the thermal energy of a fluidic system to increase their energy efficiency (referred to as the Green Machine™)

Generally, the invention provides at least two embodiments, one being retrofit and the other OEM. Design, art, and architecture are all components of this disposition. In any event, substantial reduction in electrical consumption should be attained. The device and method each include several important components. The external component is a heat exchanger, such as an aluminum or optimal automobile radiator or heater core. Research shows that the availability and cost due to inherent mass production makes for low prices. An optimal heat exchanger in relation to efficiency and cost based on basic maxima-minima calculation can be employed.

In some embodiments, the method includes photovoltaic devices, for example, to supply supplemental power (e.g., to a compressor or pump).

This system can optionally eliminate or minimize the use of a compressor which is believed to be the most power consumptive element of a conventional refrigerator/freezer. Filter techniques, as outlined above, can be used to avoid any contamination from outside air, which can be dramatic in terms of actual toxicity and related effects on food taste and texture. This system also has the effect of optionally making the entire mechanism external to the refrigerator, with the beneficial result of increased space within the appliance.

As noted above, this type of system allows for the placement of the refrigerator in the kitchen as per architecture and taste in design. This feature makes it completely distinctive to alternatives which must be close to or actually abutting walls that are exposed to the interior. The system is preferably as closed as is possible with very minimal leakage either into or outside the system. Optimally there will be almost zero coolant loss or accumulation of condensate-based water. The coolant is typically 50% product and 50% water and can be maximized technically. Freezing of the coolant should not be a problem above minus 40° C. Obviously, latitude, altitude as they relate to mean temperatures will be the determining factor. As a “ballpark” figure, a 40%-f-reduction in energy use can be anticipated in borderline or seasonal mean temperature environments predominantly at or below zero celsius and the use of timers may come into play in areas, such as the desert with extreme diurnal temperature differences. This system may even cause substantial reduction in energy use even in places such as Las Vegas in winter.

In some embodiments, the invention provides a ballast system, such as water or optimal fluids of some kind in containers which could freeze at night and provide cooling by day and adding stability to the system. Historical temperature data could be integrated into the digital segment of the system.

In general, research has shown that due to the mass production of most components of this closed system, cost and availability particularly in an era of overcapacity, should make physical components inexpensive. Therefore capital costs and power consumption elements should make even retrofit applications a very short “payout period”. Since refrigeration is one of the top electrical consuming items in a home or restaurant, aggregate electrical energy demand may be decreased substantially which should have the effect taking pressure off the entire national energy grid and reduce the need for extremely expensive capital costs of enhancing grid capacity and reducing the risk of “brownouts” or “rolling blackouts” in the future. We may be looking at the lack of very substantial and extremely expensive infrastructure improvements that could be on the order of hundreds of billions of dollars.

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. An energy-conserving chilling system comprising:
a case providing a compartment, the case being coupled to a fluid conduit and configured to be positioned within a building to allow passage of a fluid via the conduit from an exterior of the building to the case, thereby decreasing an interior temperature of air within the compartment.

2. The system of claim 1, wherein the fluid is air, and the fluid conduit comprises an intake air vent configured to draw external air into the compartment to mix with air in the compartment, thereby decreasing an overall temperature of air within the compartment.

3. The system of claim 2, further comprising one selected from the list consisting of: a filter to remove components from the air; an electric fan; and an air exhaust vent.

4. The system of claim 2, wherein the case is provided by a household refrigeration appliance.

5. The system of claim 1, wherein the fluid is a cooling fluid, and the system further comprises an external heat exchanger configured to be positioned outside of the building, wherein the external heat exchanger comprises a reservoir with an internal surface to contact the cooling fluid and an external surface to contact external air.

6. The system of claim 5, wherein the case is provided by a household refrigeration appliance, and the system further comprises an internal heat exchanger disposed within the case and coupled to the external heat exchanger by the fluid conduit to provide a closed fluid system that prevents commingling of the cooling fluid and air.

7. The system of claim 5, further comprising a fluid pump.

8. An energy-conserving method of chilling a product comprising:
drawing a fluid via a fluid conduit from outside of a building into a compartment within a case, the case being located within the building, thereby reducing an internal air temperature within the compartment.

9. The method of claim 8 wherein the fluid is air and further comprising:
activating a fan to draw in the air responsive to a determination of an external air temperature made by thermostat.

10. The method of claim 9 wherein the case is provided by a household refrigeration appliance and the compartment is a refrigeration compartment and further comprising removing air from the compartment by means of an exhaust vent

11. The method of claim 9 further comprising drawing in the air responsive to a determination that the external air temperature is lower than an internal air temperature in the refrigerator compartment and independently drawing, via a second conduit, air into a freezer compartment responsive to a determination that the external air temperature is below a freezing temperature.

12. The method of claim 8, wherein the fluid is a cooling fluid, the method further comprising:
flowing the cooling fluid through an external heat exchanger to transfer heat energy from the cooling fluid to outside air.

13. The method of claim 12 further comprising passing the cooling fluid through an internal heat exchanger disposed within the case thereby causing heat energy to be transferred from air within the case to the cooling fluid, thereby decreasing the internal air temperature.

14. The method of claim 12 further comprising causing the cooling fluid to flow by pumping the cooling fluid with a pump device.

15. An energy-conserving chilling device comprising a fluid conduit configured to be coupled to a chilling appliance to draw a fluid from outside of a building into a compartment within the chilling appliance, thereby reducing an internal air temperature within the compartment.

16. The device of claim 15, wherein the fluid is air and the fluid conduit comprises an air intake vent and a fan.

17. The device of claim 16 further comprising an air exhaust vent.

18. The device of claim 17 further comprising a thermostat configured to cause, responsive to the internal air temperature being higher than an external temperature, the fan to operate to cause air to be drawn into the compartment.

19. The device of claim 15, wherein the fluid is a cooling fluid, and the device further comprises an external heat exchanger configured to be positioned outside of the building.

20. The device of claim 19 further comprising an component, the component being one selected from the list consisting of: an internal heat exchanger configured to be installed in the chilling appliance and a fluid pump operable to assist the cooling fluid in circulating between the external heat exchanger into the compartment.
